(19) United States
(12) Patent Application Publication
(10) Pub. No.: US 2025/0142009 A1
(43) Pub. Date: May 1, 2025

(54) IMAGE FORMATION APPARATUS

(71) Applicant: Toshiba Tec Kabushiki Kaisha, Tokyo (JP)

(72) Inventor: Shinya SUGIMOTO, Mishima Shizuoka (JP)

(21) Appl. No.: 18/645,902

(22) Filed: Apr. 25, 2024

(30) Foreign Application Priority Data
Oct. 26, 2023 (JP) 2023-184101

(51) Int. Cl. H04N 1/00; G03G 21/16

(52) U.S. Cl. CPC H04N 1/00549; G03G 21/1619; H04N 1/00557; H04N 2201/0063; H04N 2201/0094

(57) ABSTRACT

In accordance with an embodiment, a casing of an image formation apparatus includes a first support member and a second support member. The first support member comes into contact with a lower end of a first support leg part projecting downward from the optical scanning device and supports the lower end of the first support leg part. The second support member comes into contact with a lower end of a second support leg part different from the first support leg part projecting downward from the optical scanning device and supports the lower end of the second support leg part. The second support member is separated from the first support member in a non-contact state.

### CROSS-REFERENCE TO RELATED APPLICATIONS

This application is based upon and claims the benefit of priority from the prior Japanese Patent Application No. 2023-184101, filed on Oct. 26, 2023, the entire contents of which are incorporated herein by reference.

### FIELD

An embodiment described here generally relates to an image formation apparatus such as a copy machine or a printer installed in a working place.

### BACKGROUND

An image formation apparatus such as a copy machine or a printer includes an optical scanning device that exposes a surface of a photosensitive drum to light and scans the surface of the photosensitive drum by emitting a light beam to the surface of the photosensitive drum, thereby forming an electrostatic latent image on the surface of the photosensitive drum. Moreover, the image formation apparatus includes a developing device that supplies a developer to the electrostatic latent image formed on the surface of the photosensitive drum to develop the electrostatic latent image, a paper feed conveyor that conveys paper, and a fixing device that fixes the developed image formed on the surface of the photosensitive drum, for example.

Motors and clutches for driving the paper feed conveyor and the developing device are vibration generation sources, and they vibrate a casing of the image formation apparatus. To prevent vibrations of the casing from being transmitted to the optical scanning device, there is an image formation apparatus in which a resonant frequency of a support member that supports the optical scanning device with respect to the casing is set to a predetermined value.

However, the casing does not vibrate at a single frequency because of the various vibration generation sources. When vibrations having a frequency different from the resonant frequency of the support member are transmitted to the optical scanning device, the optical scanning device vibrates, which may lower the quality of an output image.

### BRIEF DESCRIPTION OF THE DRAWINGS

FIG. 1 is a schematic view showing an image formation apparatus according to an embodiment.

FIG. 2 is a schematic view showing an image formation part for yellow in the image formation apparatus shown in FIG. 1.

FIG. 3 is a perspective view showing an optical scanning device and a part of a casing in the image formation apparatus shown in FIG. 1.

FIG. 4 is a perspective view showing a part of the casing from which the optical scanning device shown in FIG. 3 has been removed.

FIG. 5 is a cross-sectional view when a portion of the casing is cut along the line F5-F5 in FIG. 3.

FIG. 6 is a schematic view showing a state in which four support leg parts in the optical scanning device shown in FIG. 3 are held in contact with a support base and a support stay.

FIG. 7 is a perspective view showing three plate springs attached to the support stay shown in FIG. 4.

FIG. 8 is a perspective view showing a configuration in which the support stay shown in FIG. 4 rotatably supports the optical scanning device.

### DETAILED DESCRIPTION

In accordance with one embodiment, an image formation apparatus includes a vibration generation source. The image formation apparatus includes an optical scanning device that forms an electrostatic latent image on an image carrier with a light beam based on an image signal, and a casing that supports the vibration generation source and the optical scanning device. The optical scanning device includes a bottom surface and a first support leg part provided projecting downward from the bottom surface. The optical scanning device further includes a second support leg part provided projecting downward from the bottom surface, the second support leg part being different from the first support leg part. The casing includes a first support member that comes into contact with a lower end of the first support leg part and supports the optical scanning device. The casing further includes a second support member that is provided, separated from the first support member in a non-contact state with the first support member, comes into contact with a lower end of the second support leg part, and supports the optical scanning device.

Hereinafter, an image formation apparatus 100 according to an embodiment (hereinafter, simply referred to as an apparatus 100) will be described with reference to the drawings. It should be noted that the scales of the respective blocks in each figure used for the following description of the embodiment may be changed as appropriate. Moreover, configurations may be omitted in the figures used for the following description of the embodiment for the sake of easy understanding of the description. Moreover, in the drawings, the same reference signs denote the same or similar parts.

The apparatus 100 is a multifunction peripheral (MFP), for example. The apparatus 100 has a printing function, a scan function, a copying function, an erasable printing function, a facsimile function, and the like. The printing function is a function of forming an image on paper P. The scan function is a function of scanning an image from a document or the like on which an image has been formed. The copying function is a function of printing, for example, the image scanned from the document or the like by the scan function on the paper P by the printing function. The erasable printing function is a function of erasing an image formed on the paper P with an erasable developer.

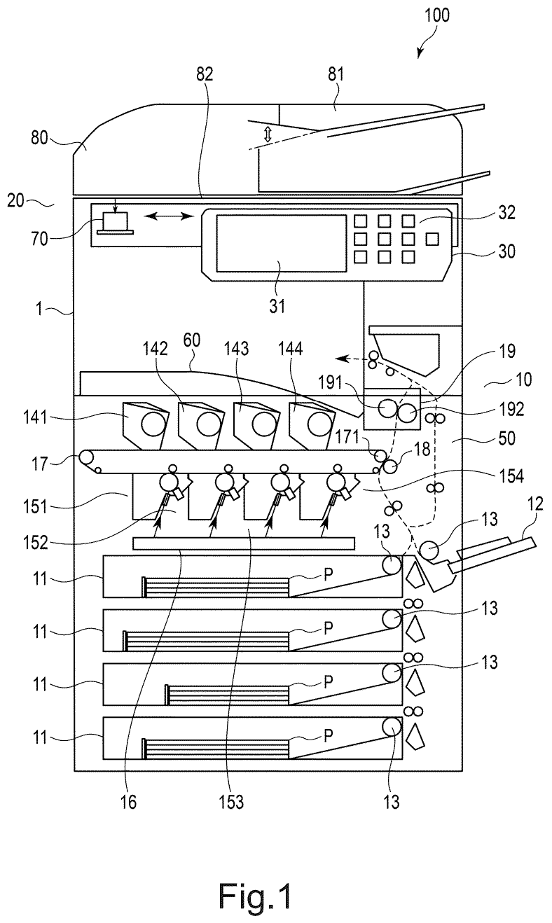

As shown in FIG. 1, the apparatus 100 includes a casing 1 forming an outer casing of the apparatus. The apparatus 100 includes a printer 10, a scanner 20, and an operation panel 30. The apparatus 100 includes the printer 10 and the scanner 20 inside the casing 1 and also includes the operation panel 30 on the front side of the casing 1. In the following description, front and rear directions, upper and lower directions, and left-and right-hand directions are defined when the apparatus 100 is viewed in FIG. 1.

The printer 10 includes a plurality of paper feed cassettes 11, a manual feed tray 12, and a plurality of paper feed rollers 13. The paper feed cassettes 11 store paper P used for printing. The manual feed tray 12 is for manually feeding paper P. The paper feed roller 13 rotates, thereby selectively taking out paper P from any one of the paper feed cassettes 11 and the manual feed tray 12.

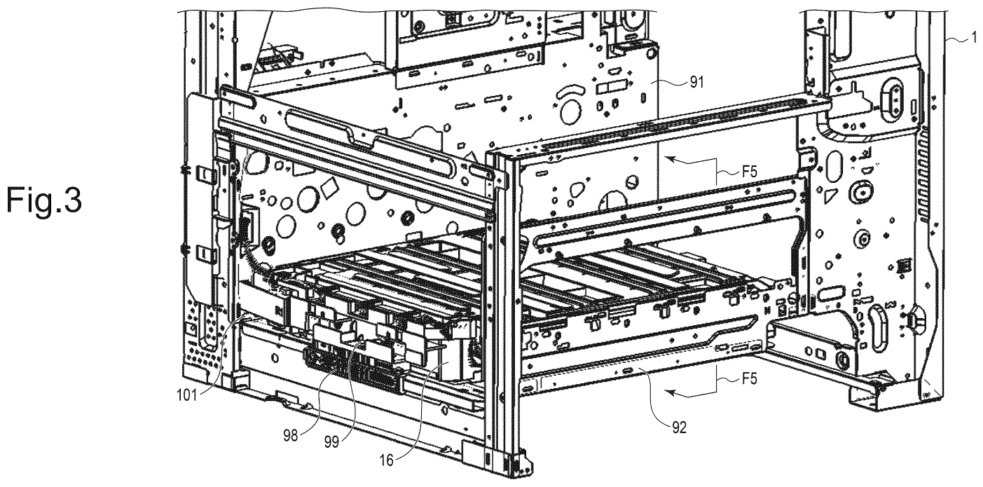

The printer 10 includes four toner cartridges 141, 142, 143, 144, four image formation parts 151, 152, 153, 154, an optical scanning device 16, a transfer belt 17, a secondary transfer roller 18, and a fixing device 19. The printer 10 includes the optical scanning device 16 below the four image formation parts 151, 152, 153, 154. The casing 1 includes an insertion part 101 (FIG. 3) for inserting and attaching the optical scanning device 16 into the casing 1 at its left side surface.

The toner cartridges 141 to 144 respectively store toner to be supplied to the image formation parts 151 to 154. The toner cartridge 141 has stored yellow (Y) toner. The toner cartridge 142 has stored magenta (M) toner. The toner cartridge 143 has stored cyan (C) toner. The toner cartridge 144 has stored black (K) toner. The toner color combination is not limited to YMCK, and another color combination may be employed. Moreover, the toner may be toner erasable at a temperature higher than a predetermined temperature.

The image formation parts 151 to 154 are respectively supplied with the toner from the toner cartridges 141 to 144 and form toner images in different colors. The image formation part 151 forms a yellow (Y) toner image. The image formation part 152 forms a magenta (M) toner image. The image formation part 153 forms a cyan (C) toner image. The image formation part 154 forms a black (K) toner image.

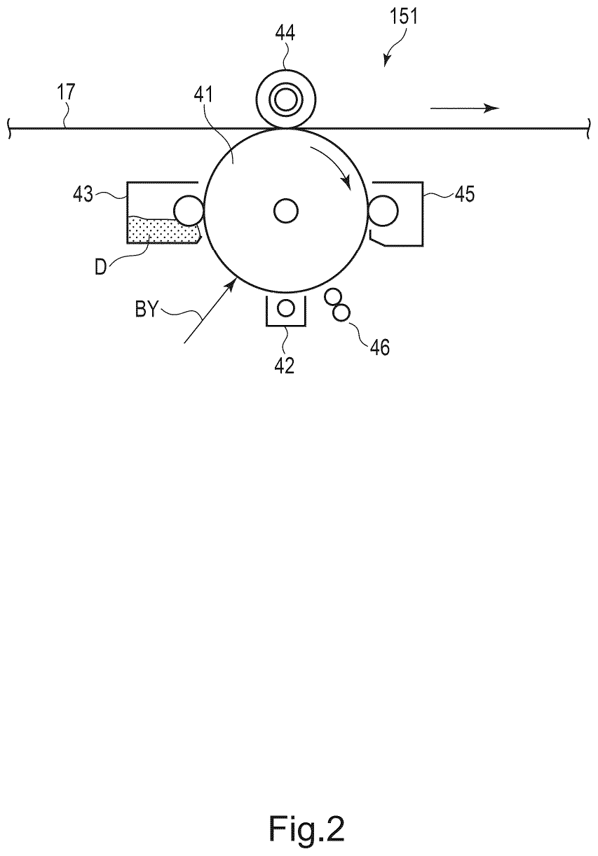

The image formation parts 151 to 154 have the same configuration except for differences in toner. Therefore, here, referring to FIG. 2, the image formation part 151 for yellow will be described as a representative and descriptions of the image formation parts 152 to 154 for other colors will be omitted.

The image formation part 151 for yellow includes a photosensitive drum 41 (image carrier), a charging unit 42, a developing unit 43, a primary transfer roller 44, a cleaner 45, and a static eliminator lamp 46.

The photosensitive drum 41 has a surface for receiving a light beam BY emitted from the optical scanning device 16. The optical scanning device 16 forms an electrostatic latent image on the surface of the photosensitive drum 41. The charging unit 42 charges the surface of the photosensitive drum 41 with negative electric charges. The developing unit 43 develops the electrostatic latent image on the surface of the photosensitive drum 41 with yellow toner D supplied from the toner cartridge 141. That is, the developing unit 43 forms a yellow toner image on the surface of the photosensitive drum 41.

The image formation part 151 includes the primary transfer roller 44 at a position opposite to the photosensitive drum 41 while sandwiching the transfer belt 17. The primary transfer roller 44 generates a transfer voltage between the primary transfer roller 44 and the photosensitive drum 41. Accordingly, the primary transfer roller 44 transfers (primarily transfers) the toner image on the surface of the photosensitive drum 41 to the surface of the transfer belt 17 in contact with the photosensitive drum 41.

The cleaner 45 removes toner remaining on the surface of the photosensitive drum 41. The static eliminator lamp 46 removes electric charges remaining on the surface of the photosensitive drum 41.

In accordance with input image data, the optical scanning device 16 emits light beams BY, BM, BC, BK to the surfaces of the photosensitive drums 41 in the image formation parts 151, 152, 153, 154, respectively. The light beams BY, BM, BC, BK are respectively based on image data of each color when the image data is decomposed into Y, M, C, K colors. The optical scanning device 16 emits a light beam BY in accordance with image data of Y components to form an electrostatic latent image for yellow onto the surface of the photosensitive drum 41 in the image formation part 151. Similarly, the optical scanning device 16 emits light beams BM, BC, BK in accordance with image data of M, C, K components to form electrostatic latent images for the respective colors onto the surfaces of the photosensitive drums 41 in the image formation parts 152, 153, 154.

It should be noted that the image data input into the optical scanning device 16 is, for example, image data scanned from a document or the like by the scanner 20. Alternatively, the image data input into the optical scanning device 16 is image data sent to the apparatus 100 from an apparatus different from the apparatus 100.

As shown in FIG. 1, the transfer belt 17 is provided as an endless belt and rotates by rotation of a driving roller 171 with the transfer belt 17 wound around it. The rotation of the transfer belt 17 conveys the respective toner images superimposed and formed on the surface of the transfer belt 17 by the image formation parts 151 to 154 to a transfer region that the secondary transfer roller 18 faces.

The secondary transfer roller 18 is opposite to the driving roller 171 while sandwiching the transfer belt 17. The secondary transfer roller 18 transfers (secondarily transfers) the toner images formed on the transfer belt 17 onto paper P passing between the driving roller 171 and the secondary transfer roller 18.

The fixing device 19 heats and presses the paper P. The fixing device 19 includes a heat roller 191 and a press roller 192. The heat roller 191 and the press roller 192 are opposite to each other while sandwiching a conveying path for the paper P. The heat roller 191 includes a heat source such as a heater. The heat roller 191 heated by the heat source comes into contact with the paper P and heats the paper P. The press roller 192 presses the paper P passing between the press roller 192 and the heat roller 191. In this manner, the fixing device 19 fixes the toner images which have been transferred to the paper P to the paper P.

The printer 10 additionally includes a duplex unit 50 and a paper output tray 60. The duplex unit 50 puts the paper P in a state in which the back of the paper P can be printed. The duplex unit 50 reverses the paper P by switching back the paper P and feeds the paper P to the transfer region between the transfer belt 17 and the secondary transfer roller 18. The paper output tray 60 is for delivering the printed paper P.

The scanner 20 scans an image from a document or the like. The scanner 20 includes a scanning module 70 and a document feed device 80.

The scanning module 70 emits illumination light to a surface of a document having an image to be scanned (hereinafter, referred to as a document surface), receives the reflected light through an image sensor (not shown), and converts the reflected light into digital signals. Accordingly, the scanning module 70 scans the image from the document surface.

The document feed device 80 is, for example, an auto document feeder (ADF). The document feed device 80 conveys documents placed on a document tray 81 through a document glass 82 one by one. The scanning module 70 scans an image from the document conveyed by the document glass 82. The document feed device 80 may include another scanning module for scanning an image from the back surface of the document.

The operation panel 30 is a man machine interface that performs input/output between the apparatus 100 and an operator of the apparatus 100. The operation panel 30 includes a touch panel 31 and an input device 32, for example.

The touch panel 31 is, for example, one obtained by stacking a display such as a liquid-crystal display or an organic EL display on a pointing device associated with touch input. The display of the touch panel 31 displays a screen for notifying the operator of the apparatus 100 of various types of information. Moreover, the touch panel 31 receives a touch operation made by the operator.

The input device 32 receives an operation made by the operator of the apparatus 100. The input device 32 is, for example, a keyboard, a key pad, or a touch pad.

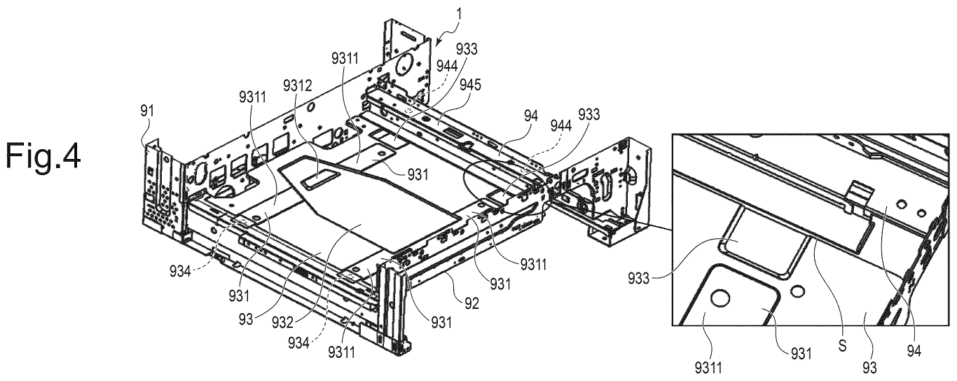

As shown in FIGS. 3 and 4, the casing 1 includes a rear frame 91 arranged on the back side of the apparatus 100, a front frame 92 arranged on the front side of the apparatus 100, a support base 93, and a support stay 94. FIG. 3 shows a state in which the image formation parts 151 to 154 and the toner cartridges 141 to 144 located above the optical scanning device 16 have been removed. FIG. 4 shows a state in which the optical scanning device 16 shown in FIG. 3 have been further removed. Therefore, in FIG. 3, the support base 93 and the support stay 94 are hidden by the optical scanning device 16, so the support base 93 and the support stay 94 can be hardly seen.

The rear frame 91 is a member formed of a sheet metal extending in the upper and lower directions and the left-and right-hand directions. The rear frame 91 includes a drive mechanism such as a motor or a clutch (not shown) on its back side. The drive mechanism drives the paper feed rollers 13 and the developing unit 43. The drive mechanism is a vibration generation source that vibrates the rear frame 91 (i.e., the casing 1) during driving of the apparatus 100.

The front frame 92 is a member formed of a sheet metal arranged in parallel with the rear frame 91 at a position spaced apart forward from the rear frame 91. The front frame 92 includes a cooling duct (not shown) between the front frame 92 and the optical scanning device 16 behind it. The cooling duct is for sending external air into a gap between the support base 93 and the optical scanning device 16 to cool a polygon motor of the optical scanning device 16.

The support base 93 is a member formed of a sheet metal arranged below the optical scanning device 16. The support base 93 is a member having a flat plate shape arranged substantially horizontally in the front and rear directions and the left-and right-hand directions. A rear end portion of the support base 93 is fixed to a front surface of the rear frame 91 and a front end portion of the support base 93 is fixed to a rear surface of the front frame 92. The fixation of the support base 93 to the rear frame 91 and the front frame 92 is performed by welding, for example. The support base 93 is an example of a first support member.

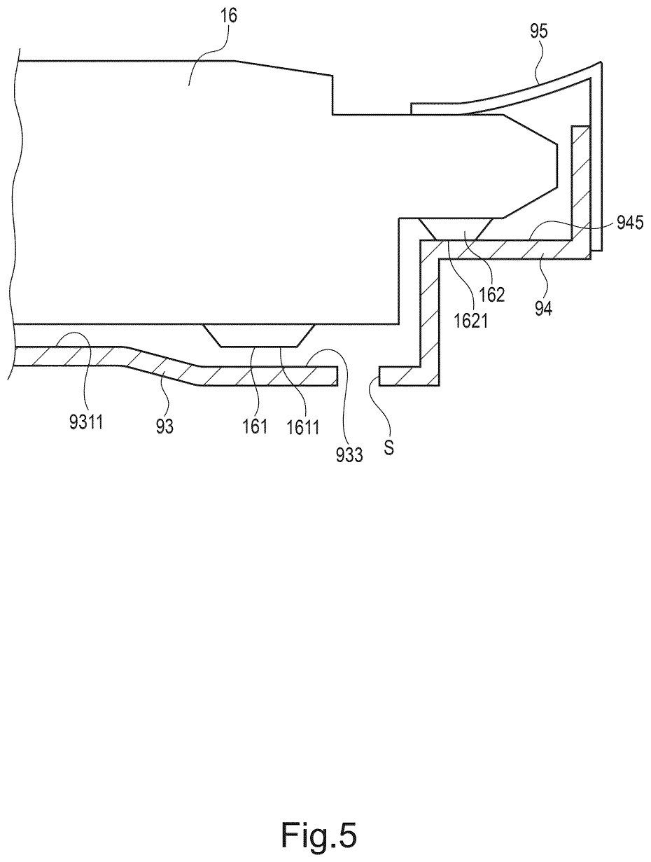

When the optical scanning device 16 is inserted and attached into the casing 1 through the insertion part 101 located on the left-hand side of the casing 1, the support base 93 functions as an insertion guide that comes into sliding contact with a lower end of a projection part 161 (FIG. 5) to be described later which projects from the lower surface (bottom surface) of the optical scanning device 16. To keep sliding contact of a sliding contact surface 1611 located at the lower end of the projection part 161 while inserting the optical scanning device 16 to a predetermined position (position shown in FIG. 3) inside the casing 1, the support base 93 needs to be a member with a sufficient length in the left-and right-hand directions and is formed of a relatively large, flat plate-shaped member.

The support stay 94 is a member formed of a sheet metal extending in the front and rear directions and arranged, spaced apart rightward from the support base 93. A rear end of the support stay 94 is fixed to the front surface of the rear frame 91 and a front end of the support stay 94 is fixed to the rear surface of the front frame 92. The fixation of the support stay 94 to the rear frame 91 and the front frame 92 is performed by welding, for example. The support stay 94 is an example of a second support member.

The support stay 94 is a member arranged, spaced apart from the support base 93 in the right-hand direction with a space therebetween. The support stay 94 is laid out so that vibrations from the support base 93 are not directly transmitted to the support stay 94. That is, a left end portion of the support stay 94 and a right end portion of the support base 93 have a clearance S physically dividing both therebetween, and the support stay 94 and the support base 93 are not in contact with each other.

As described above, providing the clearance S between the support base 93 and the support stay 94 can make it difficult to transmit vibrations of the drive mechanism provided on the rear frame 91 to the support stay 94. When the drive mechanism vibrates during operation of the apparatus 100, the rear frame 91 of the casing 1 vibrates and the vibrations are transmitted to the support base 93 and the support stay 94. Since the support base 93 has the flat plate shape functioning as the insertion guide for the optical scanning device 16, the support base 93 vibrates more violently than the support stay 94 when the vibrations are transmitted to the support base 93.

Therefore, if the support base 93 and the support stay 94 are integrally connected to each other, the vibrations of the support base 93 are directly transmitted to the support stay 94. On the contrary, when the clearance S is provided between the support base 93 and the support stay 94 to divide both as in the present embodiment, vibrations of the support base 93 are not directly transmitted to the support stay 94. As a result, as compared to a case where no clearance S is provided, vibrations of the support stay 94 can be reduced.

FIG. 5 is a cross-sectional view of a portion when the structure in FIG. 3 is cut along the line F5-F5. The optical scanning device 16 includes a plurality of projection parts 161 projecting from its lower side and a plurality of support leg parts 162. In FIG. 5, only one projection part 161 and one support leg part 162 provided near a front end in the insertion direction of the optical scanning device 16 are illustrated. However, the number of projection parts 161 and the number of support leg parts 162 and the lay-outs of the projection parts 161 and the support leg parts 162 can be arbitrarily set. In the present embodiment, the optical scanning device 16 includes, on the lower side, at least two substantially truncated cone-shaped projection parts 161 and four substantially truncated cone-shaped support leg parts 162.

When inserting and attaching the optical scanning device 16 through the insertion part 101 of the casing 1, the projection part 161 has the flat sliding contact surface 1611 that comes into sliding contact with slide surfaces 9311, 9312 (see FIG. 4) of the support base 93 at an end portion (lower end) in a direction of projection. The projection part 161 is a structure provided separate from the support leg part 162. The support base 93 has a plurality of slide convex parts 931 respectively extending in the left-and right-hand directions at positions spaced apart from each other in the front and rear directions. The slide convex parts 931 are located at positions opposite to movement paths for the plurality of projection parts 161 of the optical scanning device 16. The slide surfaces 9311, 9312 are located on upper surfaces of the plurality of slide convex parts 931 and are arranged on the same horizontal surface. The optical scanning device 16 has at least two projection parts 161 at positions spaced apart from each other at the front and rear on the front end (right end) side in the insertion direction.

When the optical scanning device 16 is inserted through the insertion part 101 located on the left-hand side of the casing 1, the sliding contact surface 1611 of the projection part 161 located near the rear right end of the optical scanning device 16 sequentially comes into sliding contact with the slide surfaces 9311, 9312 on the plurality of slide convex parts 931 arranged in line at the left and right behind the support base 93. Moreover, the sliding contact surface 1611 of the projection part 161 located near the front right end of the optical scanning device 16 sequentially comes into sliding contact with the slide surfaces 9311 of the plurality of slide convex parts 931 arranged in front of the support base 93.

As shown in FIG. 4, the support base 93 includes, at its upper surface 935, a hexagon concave part 932 for causing external air taken in through the above-mentioned flow duct to be flowed. The concave part 932 is positioned to intersect with the movement paths for the projection parts 161 of the optical scanning device 16 when the optical scanning device 16 is inserted into the casing 1. That is, the concave part 932 is positioned to overlap the slide convex parts 931. Therefore, the slide convex part 931 having a slide surface 9312 on the upper surface is present inside the concave part 932.

The slide surface 9312 of the slide convex part 931 which is arranged inside the concave part 932 is arranged on the same horizontal surface as the slide surfaces 9311 of the other slide convex parts 931 arranged at the left and right of this slide convex part 931. Therefore, also when the projection part 161 of the optical scanning device 16 passes by the concave part 932, the slide surface 9312 of the slide convex part 931 which is located inside the concave part 932 can come into sliding contact with the sliding contact surface 1611 of the projection part 161 and continue to guide insertion of the optical scanning device 16.

The support base 93 additionally includes two substantially rectangular recess parts 933. The two recess parts 933 are provided, spaced apart from each other at the front and rear at positions adjacent to the clearance S between the support base 93 and the support stay 94. The two recess parts 933 are located at positions opposite to two projection parts 161 located on the side of the front end in the insertion direction when the optical scanning device 16 is inserted and arranged at a predetermined position inside the casing 1. The bottoms of the recess parts 933 are positioned below the slide surfaces 9311, 9312 of the slide convex parts 931. That is, when the optical scanning device 16 is arranged at the predetermined position inside the casing 1 and the four support leg parts 162 support the total weight of the optical scanning device 16, the sliding contact surfaces 1611 of the two projection parts 161 float slightly upwards from the bottom surfaces of the recess parts 933 as shown in FIG. 5.

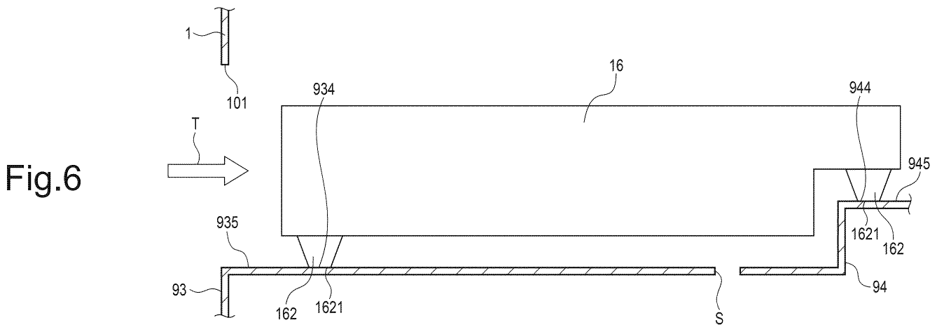

As shown in FIG. 6, the four support leg parts 162 (in FIG. 6, only two front support leg parts 162 are shown) are located near four corners of the optical scanning device 16 on the lower side. The four support leg parts 162 have substantially circular contact surfaces 1621 that respectively come into contact with four circular support regions 934, 944 shown as the broken line in FIG. 4 at tip ends (lower ends) in the direction of projection when the optical scanning device 16 is inserted to the predetermined position inside the casing 1. Specifically, the two support leg parts 162 (second support leg parts) located on the side of the front end in the insertion direction of the optical scanning device 16 respectively come into contact with support regions 944 located on an upper surface 945 of the support stay 94. Moreover, the two support leg parts 162 (first support leg parts) located on the side of the rear end of the optical scanning device 16 in the insertion direction respectively come into contact with support regions 934 located on the upper surface 935 of the support base 93 near the insertion part 101. The upper surface 945 including the support regions 944 of the support stay 94 is located at a higher position than the upper surface 935 including the support regions 934 of the support base 93.

In a state in which the optical scanning device 16 is inserted and arranged at the predetermined position inside the casing 1 (state shown in FIGS. 3, 5, and 6), the contact surfaces 1621 of the four support leg parts 162 come into contact with the upper surface 935 of the support base 93 and the upper surface 945 of the support stay 94 and the four support leg parts 162 support substantially the total weight of the optical scanning device 16. Therefore, the position of the optical scanning device 16 in the upper and lower directions depends on positions of the support regions 934, 944 in a height direction with which the four support leg parts 162 come into contact. Since the mounting position of the optical scanning device 16 in the upper and lower directions influences focal distances of emitted light beams BY, BM, BC, BK, it is necessary to adjust the position of the optical scanning device 16 in the upper and lower directions with high accuracy to form a high-quality image.

In the present embodiment, the support base 93 and the support stay 94 are respectively independently fixed to the rear frame 91 and the front frame 92. Therefore, the height position on the upper surface 935 of the support base 93 and the height position on the upper surface 945 of the support stay 94 can be separately laid out with high accuracy. Then, the position of the optical scanning device 16 in the upper and lower directions can be positioned with high accuracy by bringing the two support leg parts 162 on the deep side in the insertion direction (arrow T direction in FIG. 6) of the optical scanning device 16 into contact with the upper surface 945 of the support stay 94 and bringing the two support leg parts 162 on the front side in the insertion direction T of the optical scanning device 16 into contact with the upper surface 935 of the support base 93.

If the support base 93 and the support stay 94 are integrally fixed and fixed to the rear frame 91 and the front frame 92, it is difficult to adjust both the positions of the support regions 934 in the upper and lower directions located on the upper surface 935 of the support base 93 and the positions of the support regions 944 in the upper and lower directions located on the upper surface 945 of the support stay 94 with high accuracy. For example, in a case where a member obtained by integrating the support base 93 and the support stay 94 is fixed to the rear frame 91 and the front frame 92 by using upper and lower positions in the support regions 934 of the support base 93 as a reference, it is substantially impossible to align the support regions 944 of the support stay 94 in the upper and lower directions. In this case, the positions of the support regions 944 in the upper and lower directions may be deviated from a design value due to a dimension error caused between the support regions 934 and the support regions 944. Otherwise, in a case where the upper surface 935 of the support base 93 and the upper surface 945 of the support stay 94 which have been integrated are laid out and fixed, a distortion may be generated between the integrated support base 93 and support stay 94.

Therefore, as in the present embodiment, the support base 93 and the support stay 94 are physically separated from each other, two of the four support leg parts 162 of the optical scanning device 16 are supported by the upper surface 935 of the support base 93, and the other two support leg parts 162 are supported by the upper surface 945 of the support stay 94, such that high-accuracy positioning of the optical scanning device 16 in the upper and lower directions can be achieved. Moreover, as described above, the support base 93 and the support stay 94 are physically separated from each other and fixed to the rear frame 91 and the front frame 92, such that vibrations transmitted to the support stay 94 can be reduced and vibrations of the optical scanning device 16 can be reduced. That is, in accordance with the present embodiment, it is possible to adjust the distance between the optical scanning device 16 and the photosensitive drum 41 for each color with high accuracy, also to reduce a change in focal distance of the light beams BY, BM, BC, BK due to vibrations of the optical scanning device 16, and to achieve high-quality image formation.

Hereinafter, a mounting structure of the optical scanning device 16 to the casing 1 and a mounting procedure therefor will be described. When the optical scanning device 16 is inserted in the arrow T direction in FIG. 6 through the insertion part 101 of the casing 1, the sliding contact surfaces 1611 of the plurality of projection parts 161 of the optical scanning device 16 sequentially come into sliding contact with the slide surfaces 9311, 9312 of the plurality of slide convex parts 931 of the support base 93 shown in FIG. 4 and move toward the predetermined position while the optical scanning device 16 is guided by the support base 93.

The sliding contact surfaces 1611 of the two projection parts 161 located on the deep side in the insertion direction T of the optical scanning device 16 are detached from the slide surfaces 9311 of the slide convex parts 931 just before the optical scanning device 16 is pushed into the predetermined position and move to a position where these two projection parts 161 respectively face the two recess parts 933 of the support base 93.

On the other hand, when the two projection parts 161 are detached from the slide convex parts 931, the two support leg parts 162 on the deep side in the insertion direction T of the optical scanning device 16 come into contact with the upper surface 945 of the support stay 94. When the optical scanning device 16 is further pushed to the predetermined position, the contact surfaces 1621 of the support leg parts 162 overlap the support regions 944.

As described above, when the optical scanning device 16 is pushed to the predetermined position, the two projection parts 161 on the deep side in the insertion direction T overlap the recess parts 933 as shown in FIG. 5, such that the sliding contact surface 1611 floats from the bottoms of the recess parts 933 and some portion of the weight of the optical scanning device 16 is instead supported by the support stay 94.

Moreover, at this time, the contact surfaces 1621 of the two support leg parts 162 on the front side in the insertion direction T are held in contact with the upper surface 935 of the support base 93 at positions of the two support regions 934 of the support base 93 and the other portion of the weight of the optical scanning device 16 is supported by the support base 93. That is, in this state, substantially the total weight of the optical scanning device 16 is supported by the upper surface 935 of the support base 93 and the upper surface 945 of the support stay 94 via the four support leg parts 162 and the optical scanning device 16 is held in contact only with the support regions 934 of the support base 93. Therefore, even when the support base 93 vibrates, the vibrations are hardly transmitted to the optical scanning device 16.

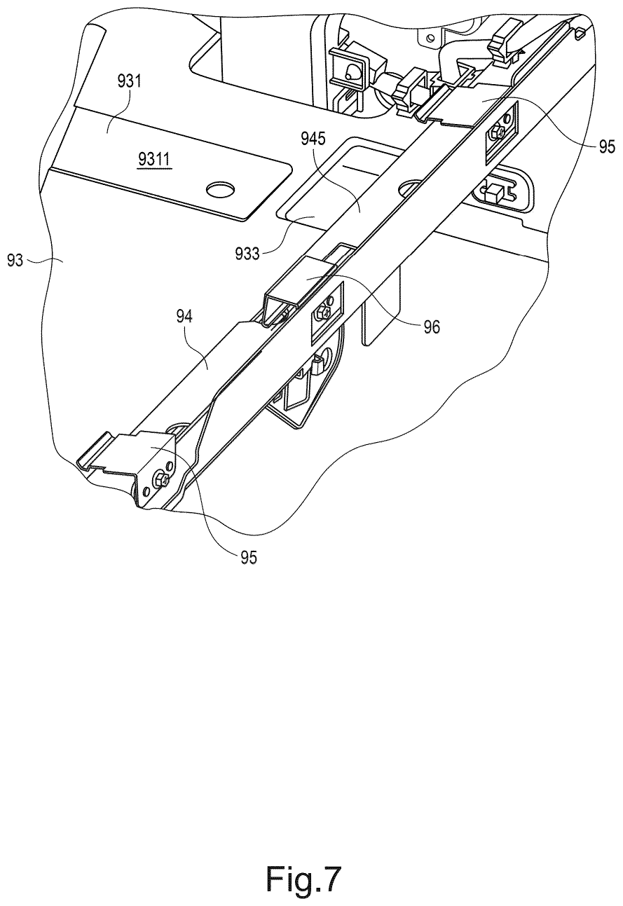

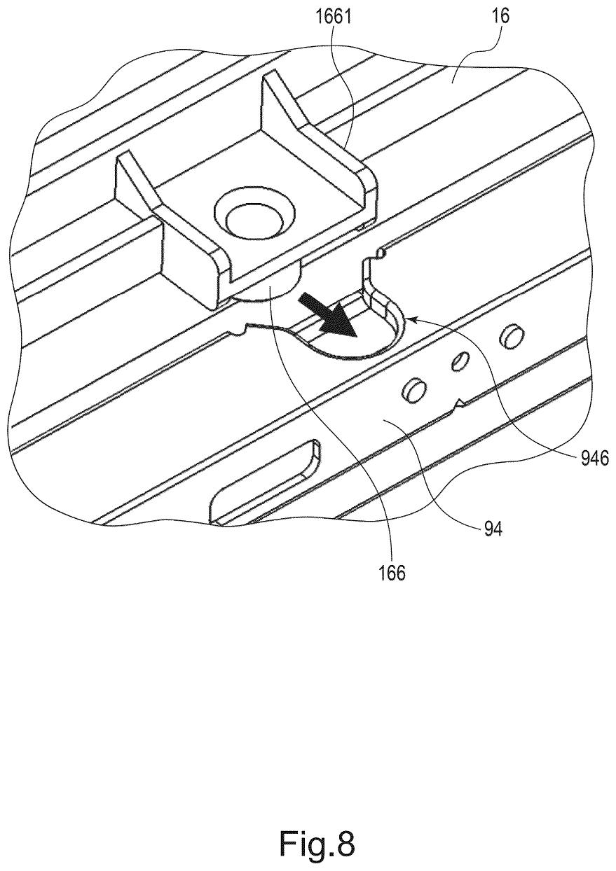

As shown in FIG. 7, the support stay 94 located on the deep side in the insertion direction T of the optical scanning device 16 includes two plate springs 95 at positions spaced apart from each other at the front and rear and one plate spring 96 at substantially the center in the front and rear directions. Moreover, as shown in FIG. 8, the support stay 94 includes a bearing recess part 946 for receiving a rotational shaft 166 of the optical scanning device 16 in vicinity of the central plate spring 96. The rotational shaft 166 is a substantially columnar member projecting to a lower side of a projection 1661 projecting to the front end in the insertion direction T of the optical scanning device 16. The rotational shaft 166 extends in the upper and lower directions.

When the optical scanning device 16 is pushed to the predetermined position shown in FIGS. 3, 5, and 6, the rotational shaft 166 of the optical scanning device 16 is fitted into the bearing recess part 946 of the support stay 94 with a clearance therebetween. That is, the optical scanning device 16 is rotatable about the rotational shaft 166 with the optical scanning device 16 pushed to the predetermined position.

Moreover, when the optical scanning device 16 is pushed to the predetermined position, as shown in FIG. 5, the front end in the insertion direction T of the optical scanning device 16 is inserted between the two plate springs 95 and the upper surface 945 of the support stay 94 and the contact surfaces 1621 of the two support leg parts 162 located on the deep side in the insertion direction T of the optical scanning device 16 are pushed against the upper surface 945 of the support stay 94. Accordingly, backlash of the optical scanning device 16 in the upper and lower directions can be eliminated.

In addition, when the optical scanning device 16 is pushed to the predetermined position, the front end in the insertion direction T of the optical scanning device 16 is pushed against the central plate spring 96 and the plate spring 96 is elastically deformed to contract on the deep side in the insertion direction T. In this state, restoration force of the plate spring 96 produces a force in a direction of pushing back the optical scanning device 16 in a direction opposite to the insertion direction T and backlash of the optical scanning device 16 in the insertion direction T can be eliminated.

As described above, after the optical scanning device 16 is pushed to the predetermined position inside the casing 1, the rear end of the optical scanning device 16 in the insertion direction T is fixed to the support base 93 by the use of the fixation member 98 shown in FIG. 3. The fixation member 98 has a hole (not shown) through which a pin 99 passes. The pin 99 projects upward in vicinity of the center in the front and rear directions of a left end portion of the optical scanning device 16. The pin 99 extends in the upper and lower directions. The fixation member 98 is slightly rotatable in relation to the optical scanning device 16.

The fixation member 98 has a structure capable of adjusting a fixation position in the front and rear directions with respect to the support base 93. Therefore, the optical scanning device 16 which has been pushed to the predetermined position is rotated by a predetermined angle about the rotational shaft 166 on the deep side in the insertion direction T and the fixation member 98 is arranged at the predetermined position in the front and rear directions and is fixed to the support base 93 at this position, such that the optical scanning device 16 can be fixed to the casing 1 at a desired angle. The angle of rotation and the position of the optical scanning device 16 in the front and rear, left and right directions are adjusted so that the scanning direction of the light beam BY, BM, BC, BK emitted from the optical scanning device 16 is parallel to the rotational axis of the photosensitive drum 41 for each image formation part 151 to 154, that is, so that no image tilt on the paper P is generated.

In particular, the following points of the above-mentioned components of the image formation apparatus 100 may be limited. 1. The frames 91, 92 fix the vibration generation source. 2. The first support member (support base 93) includes the slide convex parts 931 having the slide surfaces extending in the insertion direction in which the tip ends of the projection parts 161 of the optical scanning device 16 are held in sliding contact with them. 3. The first support member and the second support member (support stay 94) are fixed to the frames 91, 92 by welding. 4. The image formation apparatus includes the developing unit 43 that develops an electrostatic latent image. 5. The image formation apparatus 100 includes a transfer device (the transfer belt 17, the secondary transfer roller 18) that transfers the developed image (toner image) to an image-formed medium (e.g., paper). 6. The image formation apparatus 100 includes a fixing device (fixing device 19) that fixes the developed image which has been transferred to the image-formed medium to the image-formed medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image formation apparatus with a vibration generation source, comprising:
an optical scanning device that forms an electrostatic latent image on an image carrier with a light beam based on an image signal; and
a casing that supports the vibration generation source and the optical scanning device; wherein
the optical scanning device includes
a bottom surface,
a first support leg part provided projecting downward from the bottom surface, and
a second support leg part provided projecting downward from the bottom surface, the second support leg part being different from the first support leg part, and
the casing includes
a first support member that comes into contact with a lower end of the first support leg part and supports the optical scanning device, and
a second support member that is provided, separated from the first support member in a non-contact state with the first support member, comes into contact with a lower end of the second support leg part, and supports the optical scanning device.

2. The image formation apparatus according to claim 1, wherein
the casing further includes a side surface having an insertion part for inserting the optical scanning device into the casing.

3. The image formation apparatus according to claim 2, wherein
the first support member is a plate-like member horizontally arranged adjacent to the insertion part 101.

4. The image formation apparatus according to claim 2, wherein
the first support member guides the optical scanning device that is inserted into the casing through the insertion part.

5. The image formation apparatus according to claim 2, wherein
the first support member comes into contact with the bottom surface of the optical scanning device inserted into the casing through the insertion part and guides the optical scanning device.

6. The image formation apparatus according to claim 5, wherein
the optical scanning device has a projection part provided projecting from the bottom surface.

7. The image formation apparatus according to claim 6, wherein
the first support member comes into contact with a tip end of the projection part and guides insertion of the optical scanning device.

8. The image formation apparatus according to claim 3, wherein
the second support member is provided adjacent to a downstream side of the first support member in an insertion direction of the optical scanning device.

9. The image formation apparatus according to claim 8, wherein
the first support member includes a first support surface that comes into contact with the lower end of the first support leg part,
the second support member includes a second support surface that comes into contact with the lower end of the second support leg part, and
the second support surface is at a position higher than the first support surface.

10. The image formation apparatus according to claim 1, wherein
the casing includes a frame separately fixing the first support member and the second support member.
